(19) United States
(12) Patent Application Publication
(10) Pub. No.: US 2010/0138616 A1
(43) Pub. Date: Jun. 3, 2010

(54) Input-output virtualization technique

(75) Inventors: Gaurav Banga, Cupertino, CA (US); Kaushik Barde, Sunnyvale, CA (US); Richard Bramley, Mansfield, MA (US); Matthew Ryan Laue, Palo Alto, CA (US)

Correspondence Address: PHOENIX TECHNOLOGIES LTD., 915 MURPHY RANCH ROAD, MILPITAS, CA, 95035, US

(73) Assignee: PHOENIX TECHNOLOGIES LTD.

(21) Appl. No.: 12/315,435

(22) Filed: Dec. 2, 2008

(51) Int. Cl. G06F 12/00

(52) U.S. Cl. 711/154; 711/E12.001

(57) ABSTRACT

Methods, systems, apparatuses and program products are disclosed for managing device virtualization in hypervisor and hypervisor-related environment which include both pass-thru I/O and emulated I/O.

### FIELD OF THE INVENTION

The present invention generally relates to personal computers and devices sharing similar architectures, and, more particularly relates to a system and method for managing input-output data transfers to and from programs that run in virtualized environments.

### BACKGROUND OF THE INVENTION

Modernly, the use of virtualization is increasingly common on personal computers. Virtualization is an important part of solutions relating to energy management, data security, hardening of applications against malware (software created for purpose of malfeasance), and more.

One approach, taken by Phoenix Technologies® Ltd., assignee of the present invention, is to provide a small hypervisor (for example the Phoenix® HyperSpace™ product) which is tightly integrated to a few small and hardened application programs. HyperSpace™ also hosts, but is only loosely connected to, a full-featured general purpose computer environment or O/S (Operating System) such as Microsoft® Windows Vista® or a similar commercial product.

By design, HyperSpace™ supports only one complex O/S per operating session and does not virtualize some or most resources. The need to allow efficient non-virtualized access to some resources (typically by the complex O/S) and yet virtualize and/or share other resources is desirable.

I/O device emulation is commonly used in hypervisor based systems such as the open source Xen® hypervisor. Use of emulation, including I/O emulation, can result in a substantial performance hit and that is particularly undesirable in regards to resources for which there is no particular need to virtualize and/or shared and for which therefore emulation offers no great benefits.

The disclosed invention includes, among other things, methods and techniques for providing direct, or so-called pass-thru, access for a subset of devices and/or resources, while simultaneously allowing the virtualization and/or emulation of other devices and/or resources.

Thus, the disclosed improved computer designs include embodiments of the present invention enabling superior tradeoffs in regards to the problems and shortcomings outlined above, and more.

### SUMMARY OF THE INVENTION

The present invention provides a method of executing a program for device virtualization and also apparatus(es) that embodies the method. In addition program products and other means for exploiting the invention are presented.

According to an aspect of the present invention an embodiment of the invention may provide for a method of executing a program comprising: setting up a SPT (shadow page table); catching a write of an MMIO (memory mapped input-output frame number) guest PFN (Page Frame Number); normalizing the SPT and reissuing an input-output operation.

### BRIEF DESCRIPTION OF THE DRAWINGS

The aforementioned and related advantages and features of the present invention will become better understood and appreciated upon review of the following detailed description of the invention, taken in conjunction with the following drawings, which are incorporated in and constitute a part of the specification, illustrate an embodiment of the invention and in which:

FIG. 1 is a schematic block diagram of an electronic device configured to implement the input-output virtualization functionality according to an embodiment of the invention of the present invention.

FIG. 2 is a higher-level flowchart illustrating the steps performed in implementing an approach to virtualization techniques according to an embodiment of the present invention.

FIG. 3 is a block diagram that shows the architectural structure of components of a typical embodiment of the invention.

FIG. 4 is a more detailed flowchart that shows virtualization techniques used to implement I/O within an embodiment of the invention.

FIG. 5 shows how an exemplary embodiment of the invention may be encoded onto computer medium or media.

FIG. 6 shows how an exemplary embodiment of the invention may be encoded, transmitted, received and decoded using electromagnetic waves.

For convenience in description, identical components have been given the same reference numbers in the various drawings.

### DETAILED DESCRIPTION OF THE PREFERRED EMBODIMENTS

In the following description, for purposes of clarity and conciseness of the description, not all of the numerous components shown in the schematics, charts and/or drawings are described. The numerous components are shown in the drawings to provide a person of ordinary skill in the art a thorough, enabling disclosure of the present invention. The operation of many of the components would be understood and apparent to one skilled in the applicable art.

The description of well-known components is not included within this description so as not to obscure the disclosure or take away or otherwise reduce the novelty of the present invention and the main benefits provided thereby.

An exemplary embodiment of the present invention is described below with reference to the figures.

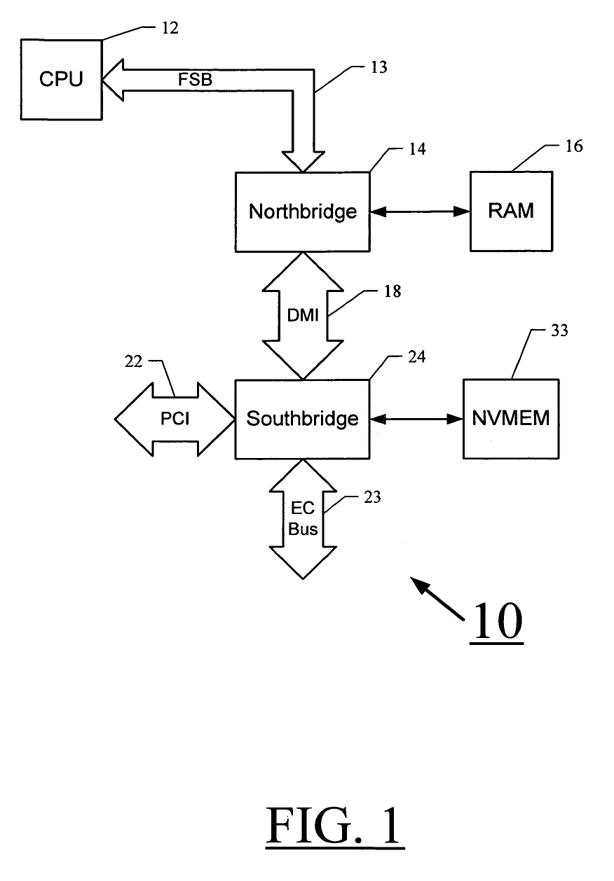

FIG. 1 is a schematic block diagram of an electronic device configured to implement the input-output virtualization functionality according to an embodiment of the invention of the present invention.

In an exemplary embodiment, the electronic device 10 is implemented as a personal computer, for example, a desktop computer, a laptop computer, a tablet PC or other suitable computing device. Although the description outlines the operation of a personal computer, it will be appreciated by those of ordinary skill in the art, that the electronic device 10 may be implemented as other suitable devices for operating or interoperating with the invention.

The electronic device 10 may include at least one processor or CPU (Central Processing Unit) 12, configured to control the overall operation of the electronic device 10. Similar controllers or MPUs (Microprocessor Units) are commonplace.

The processor 12 may typically be coupled to a bus controller 14 such as a Northbridge chip by way of a bus 13 such as a FSB (Front-Side Bus). The bus controller 14 may typically provide an interface for read-write system memory 16 such as semiconductor RAM (random access memory).

The bus controller 14 may also be coupled to a system bus 18, for example a DMI (Direct Media Interface) in typical Intel® style embodiments. Coupled to the DMI 18 may be a so-called Southbridge chip such as an Intel® ICH8 (Input/Output Controller Hub type 8) chip 24

In a typical embodiment, the ICH8 24 may be connected to a PCI (peripheral component interconnect bus) 22 and an EC Bus (Embedded controller bus) 23 each of which may in turn be connected to various input/output devices (not shown in FIG. 1). In a typical embodiment, the ICH8 24 may also be connected to at least one form of NVMEM 33 (non-volatile read-write memory) such as a Flash Memory and/or a Disk Drive memory.

In typical systems the NVMEM 33 will store programs, parameters such as firmware steering information, O/S configuration information and the like together with general purpose data and metadata, software and firmware of a number of kinds. File storage techniques for disk drives, including so-called hidden partitions, are well-known in the art and utilizes in typical embodiments of the invention. Software, such as that described in greater detail below may be stored in NVMEM devices such as disks. Similarly, firmware is typically provided in semiconductor non-volatile memory or memories.

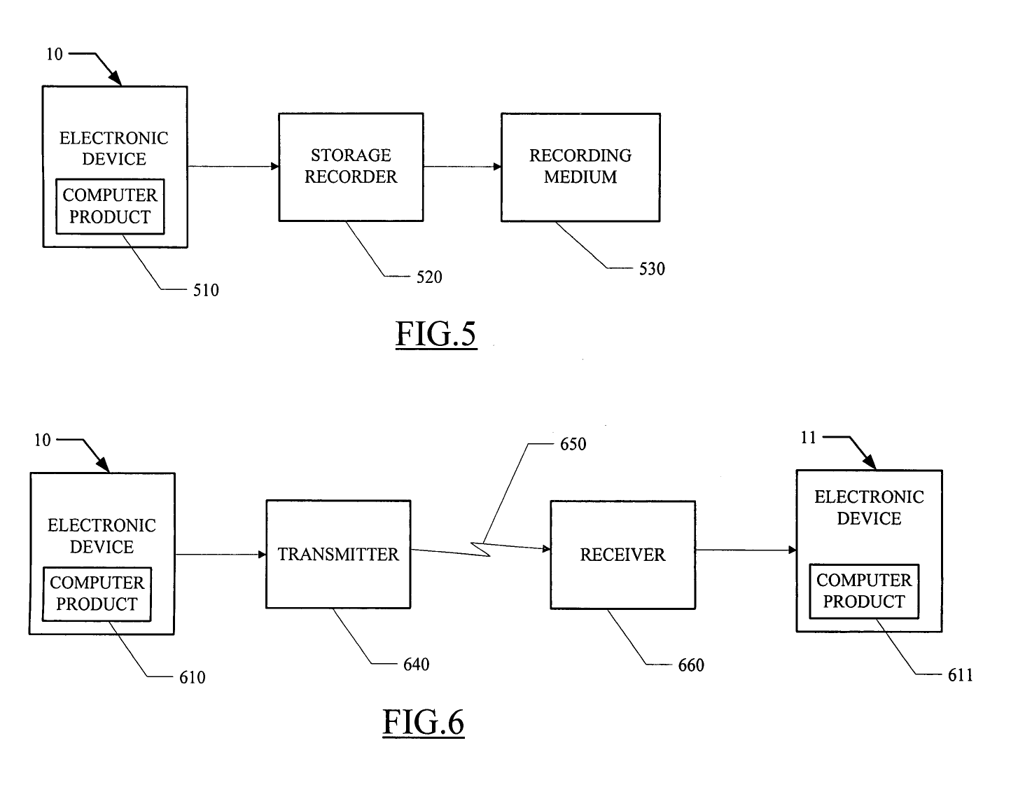

Storage recorders and communications devices including data transmitters and data receivers may also be used (not shown in FIG. 1, but see FIGS. 5 and 6) such as may be used for data distribution and software distribution in connection with distribution and redistribution of executable codes and other programs that may embody the parts of invention.

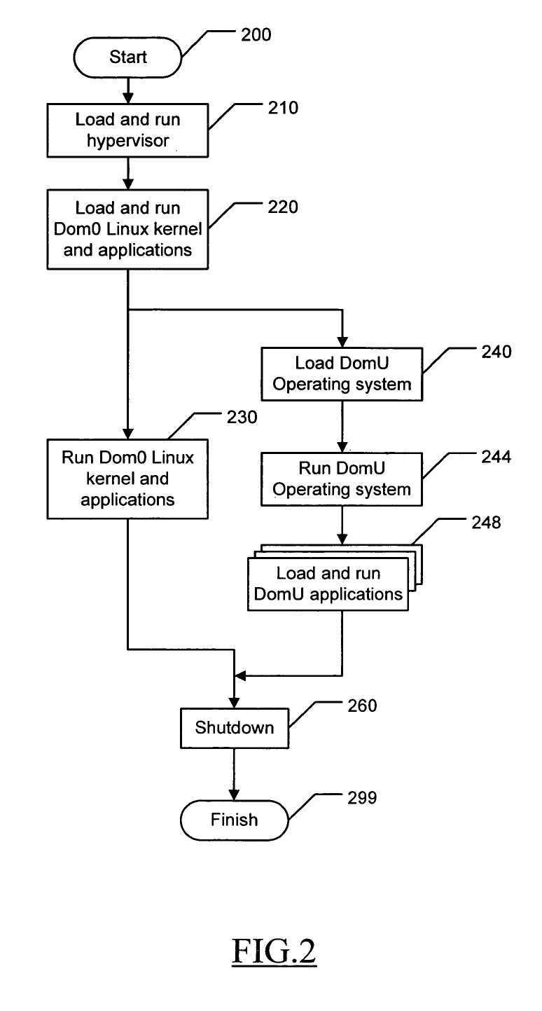

FIG. 2 is a higher-level flowchart illustrating the steps performed in implementing an approach to virtualization techniques according to an embodiment of the present invention.

Referring to FIG. 2, at step 200, in the exemplary method, a start is made into implementing the method of the embodiment of the invention.

At box 210, a hypervisor program is loaded and run. The hypervisor program may be the Xen™ program or (more typically) a derivative thereof or any other suitable hypervisor program that may embody the invention.

At box 220, the method loads and runs the Dom0 part of the hypervisor which in this exemplary embodiment comprises a multi-domain scheduler, a Linux® kernel and related applications designed to run on a Linux® kernel. It is common practice is describing hypervisor programs, especially including those derived from Xen™ as having one control domain known as Domain 0 or Dom0 together with one or more unprivileged domains (known as Domain U or DomU), each of which provides a VM (Virtual Machine).

Dom0 (Domain 0) invariably runs with a more privileged hardware mode (typically a CPU mode) and/or a more privileged software status. DomU (Domain U) operates in a relatively less privileged environment. Typically there are instructions which cause traps and/or events when executed in DomU but which do not cause such when executed in Dom0. Traps and the catching of traps, and events and their usage are well known in the computing arts.

At Box 230, a Linux® kernel and related applications are run within Dom0. This proceeds temporally in parallel with other steps.

Within the DomU part of the hypervisor program a number of steps are run in parallel with the aforementioned Dom0 Linux® kernel and associated application program(s). Thus, at box 240 the guest operating system is loaded. In a typical embodiment the guest operating system loaded into DomU may be a Microsoft® Windows® O/S product or similar commercial software.

At box 244, the DomU operating system is run. Since the DomU operating system is, in a typical embodiment of the invention, a full-featured guest O/S, it may typically take a relatively long time to reach operational readiness and begin running. Thus, Dom0 Linux® based applications may run 230 while the guest operating system is initializing to its “ready” state.

At box 248, DomU (guest O/S) application programs are loaded and run under the control of the guest operating system. As indicated in FIG. 2, there may typically be multiple applications simultaneously loaded and run 248 in DomU. Typically, though not essentially, there will only be one application at a time run in Dom0 230.

At box 260, when both Dom0 applications and DomU applications reach completion, the computer may perform its various shutdown processes and then at box 299 the method is finished.

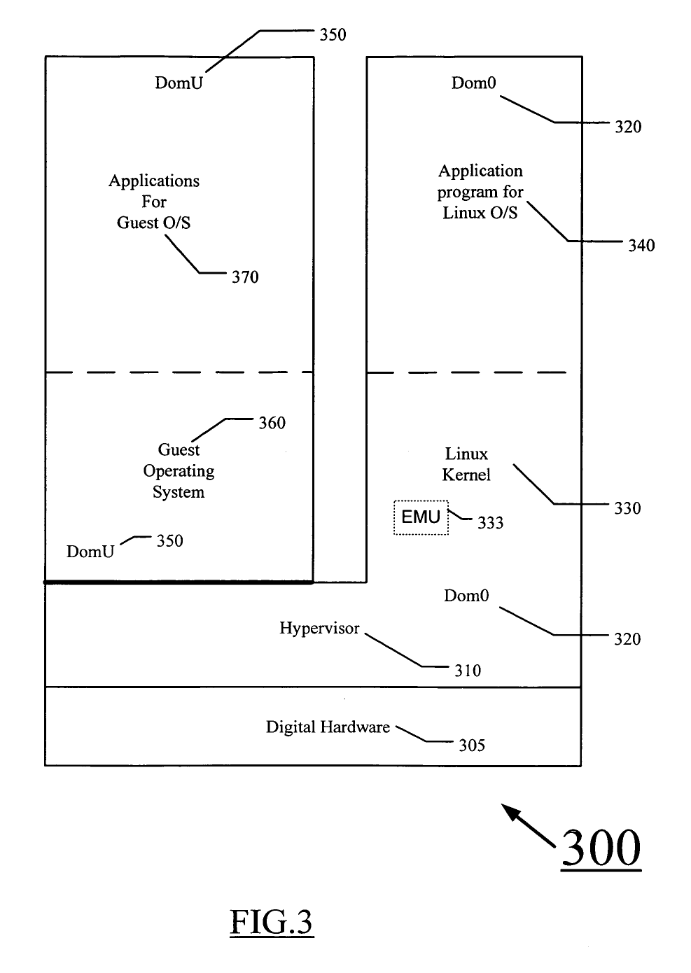

FIG. 3 is a block diagram that shows the architectural structure 300 of the software components of a typical embodiment of the invention.

The hypervisor 310 is found near the bottom of the block diagram to indicate its relatively close relationship with the computer hardware 305. The hypervisor 310 forms an important part of Dom0 320, which (in one embodiment of the invention) is a modified version of an entire Xen® and Linux® software stack.

Within Dom0 lies the Linux® kernel 330 program, upon which the applications 340 programs for running on a Linux® kernel may be found.

Also within the Linux kernel 330 lies EMU 333 (I/O emulator subsystem) which is a software or firmware module whose main purpose is to emulate I/O (Input-Output) operations.

Generally speaking, the application program (usually only one at a time) within Dom0 runs in a relatively privileged CPU mode, and such programs are relatively simple and hardened applications in a typical embodiment of the invention. CPU modes and their associated levels of privilege are well known in the relevant art.

Running under the control of the hypervisor 310 is the untrusted domain—DomU 350 software. Within the DomU 350 lies in the guest O/S 360, and under the control of the guest O/S 360 may be found (commonly multiple) applications 370 that are compatible with the guest O/S.

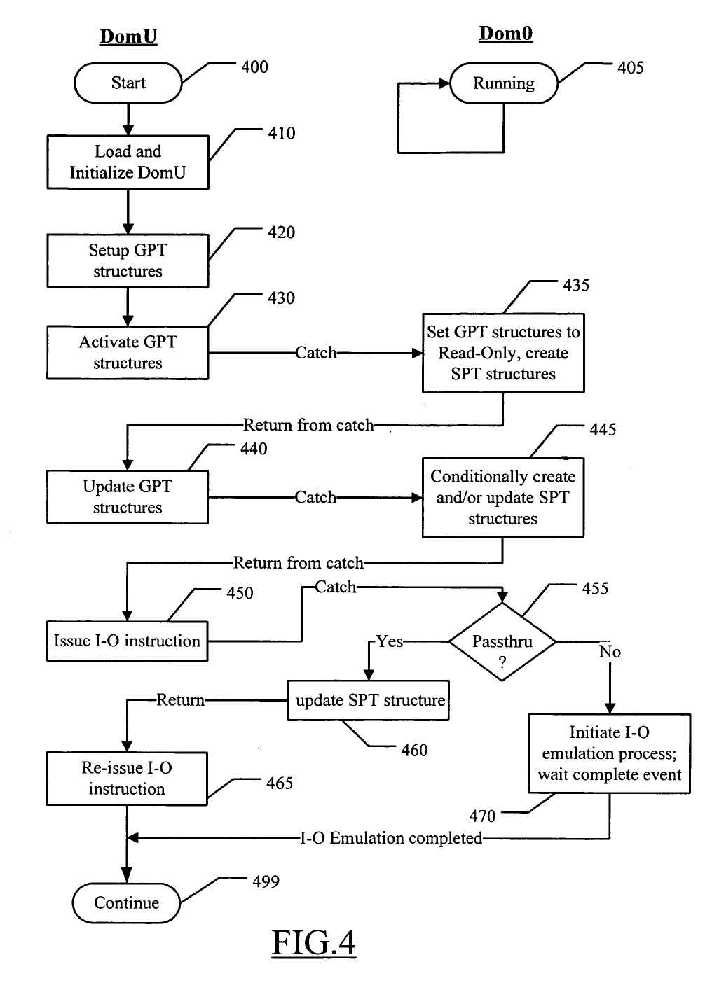

FIG. 4 is a more detailed flowchart that shows certain virtualization techniques used to implement I/O within an embodiment of the invention. Within FIG. 4, the left column is labeled DomU and the right column is labeled Dom0 and the various actions illustrated each take place within the corresponding column/process. Box 405 indicates that the Dom0 process is always running, ultimately as an idle loop, within an embodiment of the invention. In the context of FIG. 4 we may assume that the Dom0 process is already initialized and running.

At box 400, the process for DomU starts and at box 410 the DomU process is loaded and initialized. At box 420 the GPT (guest page table) structures are setup.

The type and nature of the GPT structures will vary greatly from one CPU architecture to another. For example, the Intel IA-32 and x86-64 architectures may provide for an entire hierarchy of tables within guest page table structures. Such hierarchies may contain a page table directory, multiply cascaded or nested page tables and other registers and/or structures according to the address mode in use, whether page address extensions are enabled, the sizes of the pages used and so on. The precise details of the guest page table structures are not a crucial feature of the invention, but invariably the GPT structures will, one way or another, provide for the mapping of virtual addresses to physical memory addresses and/or corresponding or closely related frame numbers. Moreover, depending on O/S implementation choices there may be multiple GPT structures, typically these are on a per-process basis within the guest O/S.

At box 430 the GPT structures are activated. Box 435 shows the GPT activation is trapped and responsively caught 435 by code which is running in Dom0. This scheme of catching instructions that raise some form of trap or exception is well known in the computing arts and involves not merely transfer of control but also (typically) an elevation of CPU privilege level or similar. In a typical embodiment using a common architecture this trap may take the form of a VT (Intel® Virtualization Technology) instruction trap.

Within the general scope of the invention, it is not strictly necessary to trap and catch the actual activation of the GPT structures—an action unequivocally or substantially tied to the activation may be caught instead. According to the CPU architecture involved the trapping and catching may take any of a number of forms. For example, in the Intel IA-32 architecture, page tables may be activated by writing to CR3 (control register number three). Alternatively an equivalent action could (for example) be the execution of an instruction to invalidate the contents of a relevant TLB (translation look aside buffer) that is for use for caching addresses that are used in paging. Invalidating a TLB (and thereby causing it to be flushed and rebuilt) is not strictly an updating of a GPT that is cached within the TLB, however it is substantially equivalent since in practice the reason for invalidating a TLB is almost always that the page cached has (at least potentially) been updated.

Box 435 then is executed responsive to activation (or equivalent) of the GPT structures. Within the action of box 435 the GPT structures may be set to read-only properties, or to some effectively substantially equivalent state. That is to say in a typical architecture pages of memory that actually contain the GPT structures are set to have read-only characteristics. In a typical architecture this effects that (at least some of) the pages which contain the GPT structures have the property that if they are written to from within an unprivileged domain such as DomU—then a GPF (General Protection Fault) will be caused. A purpose of such a technique reflects the fact that the GPT structures are created and maintained by the guest operating system, but their contents are monitored and supervised by the hypervisor program.

Still referring to box 435 within Dom0 the hypervisor creates SPT (shadow page table) structures. As the name suggests, the SBT structures are substantially copies of the GPT structures (with a relatively small amount of modification), however the SPT structures control and direct memory accesses and are a central feature of the virtualization techniques used by the hypervisor program. SPT structures may typically include a page table directory and one or more shadow page tables, and may also include a SPTI (Shadow Page Table Information block) which is used for internal hypervisor purposes to keep track of these things. The SPTI may not be visible to the hardware but may be more of a hypervisor software entity.

Upon completion of the actions of box 435 a return from the Catch is made and control transfers back to DomU.

It may be possible to bring forward or to defer the creation and/or setup of SPT structures within the general scope of the invention and pursuant or responsive to paging related actions in DomU substantially as described or equivalent thereto. A “just in time” approach to SPT structure contents may be adopted within the general scope of the invention, however the various SPT changes will be made pursuant to the various actions as described, or, alternatively, the actions may be deferred until a related event occurs. Thus, an action in the hypervisor may be responsive to an action in the DomU unprivileged domain of the guest program without there necessarily being a tight temporal coupling between the two.

At box 440, control is regained by DomU and at some point the GPT structures are updated by code executing in DomU. This may involve a write to a page containing a GPT structure, and if the relevant page has previously been marked read-only the result of writing within DomU will be a further GPF which is duly caught by the hypervisor in Dom0. The hypervisor in Dom0 can write to either or both of GPT and SPT structures as needed to synchronize or normalize the tables to maintain the desired tracking. Although not shown in FIG. 4, other implementations of embodiments of the invention may defer to setting up of SPT entries until a later time. Provided the relevant SPT entry for MMIO transaction is set up no later than immediately prior to a respective MMIO transaction itself then it will be timely. However, even in such implementations, the setting up or normalizing of the SPT is nonetheless responsive to such particular behavior(s) of the guest program.

Entries in the GPT structures may refer to RAM (random access memory) or alternatively to MMIO (memory mapped input-output) addresses. Depending in part upon which CPU architecture is pertinent, MMIO addresses in GPTs may be guest PFNs (Page Frame Numbers) which in some embodiments may simply be trapped or shadowed into an SPT. Or in other embodiments (such as Intel® VT-d for Virtualization Directed input-output) they may be Guest PFNs (Page Frame Numbers) that are interpreted by a hardware IOMMU (Input-Output Memory Map Unit) or a similar device.

The hypervisor can know (typically from configuration information maintained in, and retrieved from, non-volatile memory and sometimes using the results of PCI enumeration) whether the GPT structure entry refers to RAM or alternatively to MMIO. In the case of PCI (peripheral control interface) devices, the value written to a PCI BAR (Base Address Register) defines the datum and size of a block of MMIO PAs and hence of corresponding MMIO Guest PFNs. The usage of PCI BAR in general is well-known in the art. Thus in many, but not necessarily all, cases there is a one to one mapping between an I/O resource set associated with a PCI BAR and an MMIO PFN.

GPTs may also be updated for Guest RAM address entries but they are not especially relevant here, however they may be trapped and identified as such (i.e. as not for an MMIO address).

If the updating to the GPT structures is a result of the guest O/S adding an MMIO address to a table then the hypervisor program will have at least one decision to make. Essentially, an MMIO address may either refer to an unused MMIO address (i.e. no device is present at that address), or to an MMIO address at which a device is to be emulated, or to an MMIO address for which the guest O/S is to have “Pass-thru” access. “Pass-thru” access refers to enabling a capability in which the guest O/S is allowed to control the hardware located at the MMIO address more directly, as contrasted with having those I/O operations trapped and then emulated by the hypervisor (optionally in cooperation with code in dom0).

References (or attempted I/O) to non-existent MMIO addresses may happen. The resultant page faults may in those circumstances be caught by the hypervisor, the standard action in such cases being to terminate the requesting DomU process (or the entire DomU domain, such as the entire O/S program) unless it is an anticipated result of operating system performing probing or enumeration of peripheral subsystems. Having completed the actions associated with box 445, a return from the catch is made and control returns to DomU.

The first time a process within DomU issues a memory instruction to a particular valid MMIO address 450, that particular MMIO instruction is page faulted and caught and control returns again to Dom0 at box 455. The MMIO address will be page faulted because it falls within a page whose datum is given by the respective MMIO PFN. Moreover, the MMIO address does not necessarily fall at a page datum, indeed it may commonly be at a particular well-known offset therefrom. Page sizes of 4 k bytes are common but are not universal, larger sizes, sometimes much larger sizes, are commonplace too.

The hypervisor, running in Dom0, may now make a decision in regards to whether the MMIO operation is for Pass-thru or alternatively for Emulation; this is shown in box 455 of FIG. 4. If the I/O operation is to be emulated then control passes to box 470.

The procedures for emulating I/O using a hypervisor are well-known and as shown in box 470 involve, among other things, initiating the I/O emulation process and waiting for an event to signify completion of the I/O emulation. For example, the Xen™ hypervisor provides various means such as Event Channels to facilitate such action as is well-known in the art.

On the other hand if the guest operating system is to have Pass-thru privilege as to the MMIO address then, at box 460, the SPT structure is updated to normalize (synchronize) it so that further references in DomU to the MMIO address will not cause an immediate page fault. Thus, a return to DomU is made and at box 465 in a way that causes the I/O instruction to be reissued. When the MMIO instruction is reissued it will be applied directly (usually to the underlying hardware) and it will not be trapped and caught.

Eschewing emulation in favor of pass-thru eliminates many traps and handlers thus resulting in shorter execution paths and in some cases much higher overall performance. Typically the hypervisor will know which of emulation or pass-thru applies to a particular device from configuration information previously received. There may also be devices in which the Dom0 applications have no interest or alternatively for which the only available device drivers reside in the guest O/S; in such cases pass-thru may be desirable, or even the only feasible alternative, irrespective of performance issues. For example, some obscure peripheral devices have only available device drivers that interoperate with Microsoft® Windows® Vista® O/S.

At box 499 the method is completed.

There may be multiple GPTs and corresponding SPTs or there could conceivably be only one GPT and one SPT in an embodiment. Although the invention is operative in a single GPT structure system, in practice typical systems will have multiple GPT structures and these will typically, but not necessarily, be implemented as one GPT structure per process of a multi-processing guest O/S. For each GPT structure there will typically be an SPT structure. Moreover, it should be recalled that each GPT structure may typically consist of at least a Page Table Directory that references a Guest Page Table itself. In many cases there are more than one GPT per GPT structure. For example in X86-64 architecture machines there may typically be four levels of tables per process, that is to say a Guest Page Table with three levels of guest page tables cascaded therefrom, per process. The number of GPT structures is not critical within the scope of the invention.

FIG. 5 shows how an exemplary embodiment of the invention may be encoded onto a computer medium or media.

With regards to FIG. 5, computer instructions to be incorporated into in an electronic device 10 may be distributed as manufactured firmware and/or software computer products 510 using a variety of possible media 530 having the instructions recorded thereon such as by using a storage recorder 520. Often in products as complex as those that deploy the invention, more than one medium may be used, both in distribution and in manufacturing relevant product. Only one medium is shown in FIG. 5 for clarity but more than one medium may be used and a single computer product may be divided among a plurality of media.

FIG. 6 shows how an exemplary embodiment of the invention may be encoded, transmitted, received and decoded using electromagnetic waves.

With regard to FIG. 6, additionally, and especially since the rise in Internet usage, computer products 610 may be distributed by encoding them into signals modulated as a wave. The resulting waveforms may then be transmitted by a transmitter 640, propagated as tangible modulated electromagnetic carrier waves 650 and received by a receiver 660. Upon reception they may be demodulated and the signal decoded into a further version or copy of the computer product 611 in a memory or other storage device that is part of a second electronic device 11 and typically similar in nature to electronic device 10.

Other topologies devices could also be used to construct alternative embodiments of the invention.

The embodiments described above are exemplary rather than limiting and the bounds of the invention should be determined from the claims. Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method of executing a program comprising:
setting up a SPT (shadow page table) structure in response to trapping an action of a guest program;
catching a first write of a first MMIO (memory mapped input-output) guest PFN (Page Frame Number), the first write being to a GPT (guest page table) structure of the guest program;
normalizing the SPT structure to reflect the first MMIO guest PFN; and
reissuing a first input-output operation that is to an MMIO address in a page referenced by the first MMIO guest PFN.

2. The method of claim 1 wherein the step of:
setting up the SPT structure is performed by a hypervisor program.

3. The method of claim 1 further comprising:
catching a second write of a second memory MMIO (memory mapped input-output) guest PFN (Page Frame Number), the second write being to the GPT structure and
emulating a second input-output operation that is to an MMIO address in a page referenced by the second MMIO guest PFN.

4. The method of claim 1 wherein:
the first write is of a MMIO (memory mapped input-output) guest PFN (Page Frame Number) having an equal value to a corresponding value written to a PCI (peripheral control interface) BAR (Base Address Register).

5. The method of claim 4 wherein:
the guest program is a multi-tasking operating system program.

6. The method of claim 3 wherein:
the guest program is an operating system running in an unprivileged domain and
the emulating step is performed in a service selected from a list consisting of a hypervisor program and the hypervisor program acting together with a control domain.

7. The method of claim 1 wherein:
a GPT selected from the GPT structure is marked for read-only properties and
the step of catching the first write is or, is in response to, catching an attempt to write to a page of memory that is marked for read-only access, the read-only access being by the guest program.

8. The method of claim 1 further comprising the step of:
setting up multiple SPTs and at least one SPTI (shadow page table information block) for each of a plurality of GPTs created by the guest program.

9. A computer program product comprising:
at least one computer-readable medium having instructions encoded therein, the instructions when executed by at least one processor cause said at least one processor to
operate for input-output virtualization by steps comprising the acts of:
setting up a SPT (shadow page table) structure in response to trapping an action of a guest program;
catching a first write of a first MMIO (memory mapped input-output) guest PFN (Page Frame Number), the first write being to a GPT (guest page table) structure of the guest program;
normalizing the SPT structure to reflect the first MMIO guest PFN; and
reissuing a first input-output operation that is to an MMIO address in a page referenced by the first MMIO guest PFN.

10. The computer program product of claim 9 wherein the acts further comprise:
catching a second write of a second memory MMIO (memory mapped input-output) guest PFN (Page Frame Number), the second write being to the GPT structure and
emulating a second input-output operation that is to an MMIO address in a page referenced by the second MMIO guest PFN.

11. The computer program product of claim 9 wherein:
setting up the SPT structure is performed by a hypervisor program and the guest program is an operating system running in an unprivileged domain.

12. A method comprising:
an act of modulating a signal onto an electromagnetic carrier wave impressed into a tangible medium, or of demodulating the signal from the electromagnetic carrier wave, the signal having instructions encoded therein, the instructions when executed by at least one processor causing said at least one processor to
operate for input-output virtualization by steps comprising the acts of:
setting up a SPT (shadow page table) structure in response to trapping an action of a guest program;
catching a first write of a first MMIO (memory mapped input-output) guest PFN (Page Frame Number), the first write being to a GPT (guest page table) structure of the guest program;
normalizing the SPT structure to reflect the first MMIO guest PFN; and
reissuing a first input-output operation that is to an MMIO address in a page referenced by the first MMIO guest PFN.

13. The method of claim 12 wherein the acts further comprise:
catching a second write of a second memory MMIO (memory mapped input-output) guest PFN (Page Frame Number), the second write being to the GPT structure and
emulating a second input-output operation that is to an MMIO address in a page referenced by the second MMIO guest PFN.

14. The method of claim 12 wherein:
setting up the SPT structure is performed by a hypervisor program and the guest program is an operating system running in an unprivileged domain.

15. An electronic device comprising:
at least one controller; and
at least one non-volatile memory having instructions encoded therein, the instructions when executed by the controller cause said controller to
operate for input-output virtualization by steps comprising the acts of: setting up a SPT (shadow page table) structure in response to trapping an action of a guest program;
catching a first write of a first MMIO (memory mapped input-output) guest PFN (Page Frame Number), the first write being to a GPT (guest page table) structure of the guest program;
normalizing the SPT structure to reflect the first MMIO guest PFN; and
reissuing a first input-output operation that is to an MMIO address in a page referenced by the first MMIO guest PFN.

16. The electronic device of claim 15 wherein the instructions when
executed by the controller further cause said controller to
catching a second write of a second memory MMIO (memory mapped input-output) guest PFN (Page Frame Number), the second write being to the GPT structure and
emulating a second input-output operation that is to an MMIO address in a page referenced by the second MMIO guest PFN.

17. The electronic device of claim 15 wherein:
setting up the SPT structure is performed by a hypervisor program and the guest program is an operating system running in an unprivileged domain.
